(19) United States
(12) Patent Application Publication
(10) Pub. No.: US 2006/0136974 A1
(43) Pub. Date: Jun. 22, 2006

(54) Apparatus for SCORM-based e-learning contents service in digital broadcasting system and method thereof

(75) Inventors: Seung Wook Lee, Taejon (KR); Hye Won Jung, Seoul (KR); Jin Ho Kim, Taejon (KR); Kyung Ae Moon, Taejon (KR); Hyun Bin Kim, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/122,073

(22) Filed: May 5, 2005

(30) Foreign Application Priority Data
Dec. 21, 2004 (KR) 2004-109127

(51) Int. Cl. H04N 7/173; H04N 7/16

(52) U.S. Cl. 725/113; 725/135; 725/100; 725/112

(57) ABSTRACT

An apparatus for a SCORM-based e-learning contents service in a digital broadcasting system and a method thereof that makes it possible to implement a SCORM-based e-learning method that is a PC-based leaning method currently recognized as the standard of the e-learning industries in an MPEG-2-based digital broadcasting system. The apparatus includes a set top box for transmitting information about a kind of terminal through a return channel and then reproducing a learning TS received through a broadcasting network on a digital television (TV) receiver in accordance with received XML sync information if a user is authenticated, a learning management system for transmitting an API adaptor supportable in the set top box through the return channel in accordance with the terminal kind information transmitted from the set top box, and a digital TV transmitter for generating the learning TS by packaging learning moving-picture data, learning data and sequencing information transmitted from the learning management system, generating the XML sync information, and transmitting the learning TS and the XML sync information through the broadcasting network.

### BACKGROUND OF THE INVENTION

1. Field of the Invention

The present invention relates to an apparatus for a SCORM-based e-learning contents service in a digital broadcasting system and a method thereof, and more particularly to an apparatus for a SCORM-based e-learning contents service in a digital broadcasting system and a method thereof that makes it possible to implement a SCORM (Sharable Content Object Reference Model)-based e-learning method that is a PC-based leaning method currently recognized as the standard of the e-learning industries in an MPEG-2-based digital broadcasting system.

2. Background of the Related Art

Currently, with the fusion of broadcastings and communications, the demand for other terminals' access of e-learning contents provided from a PC is steadily increasing. In addition, the demand for a T-learning performed through television (TV) rather than the PC-based e-learning is daily increasing in groups of children, elderly people and old people. Up to now, most T-learning systems through TV merely perform the transmission of moving-picture data based on an analog broadcasting. Recently, with the appearance of satellite broadcasting technology, new business models such as downloading and learning of e-learning-related contents such as games at times desired by a user have been proposed. However, such systems or models have the drawbacks in that they can merely provide the rudimentary type bidirectionality and have not yet been standardized.

### SUMMARY OF THE INVENTION

Accordingly, the present invention is directed to an apparatus for a SCORM-based e-learning contents service in a digital broadcasting system and a method thereof that substantially obviate one or more problems due to limitations and disadvantages of the related art.

It is an object of the present invention to provide an apparatus for a SCORM-based e-learning contents service in a digital broadcasting system and a method thereof that makes it possible to implement a SCORM (Sharable Content Object Reference Model) e-learning that is recognized as the standard of the e-learning industries in an MPEG-2-based digital broadcasting system.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

In order to achieve the above and other objects, there is provided an apparatus for a SCORM (Sharable Content Object Reference Model)-based e-learning contents service in a digital broadcasting system, according to the present invention, which comprises a set top box for transmitting information about a kind of terminal through a return channel and then reproducing a learning transport stream (TS) received through a broadcasting network on a digital television (TV) receiver in accordance with received XML (Extensible Markup Language) sync information if a user is authenticated, a learning management system for transmitting an API (Application Program Interface) adaptor supportable in the set top box through the return channel in accordance with the terminal kind information transmitted from the set top box, and a digital TV transmitter for generating the learning TS by packaging learning moving-picture data, learning data and sequencing information transmitted from the learning management system, generating the XML sync information, and transmitting the learning TS and the XML sync information through the broadcasting network.

In another aspect of the present invention, there is provided a method for a SCORM (Sharable Content Object Reference Model)-based e-learning contents service in a digital broadcasting system, which comprises a first step of transmitting login information through a return channel if a login is performed after a user selects a broadcasting channel, a second step of transmitting information about a kind of terminal through the return channel if a cession is generated after the user is authenticated, a third step of transmitting an API adaptor supportable in a set top box through the return channel in accordance with the terminal kind information, a fourth step of generating a learning transport stream (TS) and XML (Extensible Markup Language) sync information, a fifth step of transmitting the learning TS and the XML sync information through a broadcasting network, and a sixth step of reproducing the learning TS in accordance with the XML sync information received through the broadcasting network.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an apparatus for a SCORM-based e-learning contents service in a digital broadcasting system according to an embodiment of the present invention;

FIG. 2 is a block diagram of an MPEG TS generator in a DTV transmitter illustrated in FIG. 1;

FIG. 3 is a view illustrating XML sync information generated when a learning TS is generated in the DTV transmitter illustrated in FIG. 1;

FIG. 4 is a view explaining a procedure of storing a learning TS decoded by a contents decoder in a set top box illustrated in FIG. 1 in a PDR,

FIG. 5 is a view explaining a method of selecting learning moving-picture data and learning data executed on a DTV illustrated in FIG. 1 using a remote controller; and

FIG. 6 is a flowchart illustrating a method for a SCORM-based e-learning contents service in a digital broadcasting system according to an embodiment of the present invention.

### DETAILED DESCRIPTION OF THE PREFERRED EMBODIMENT

The apparatus for a SCORM-based e-learning contents service in a digital broadcasting system and a method thereof according to the preferred embodiment of the present invention will now be explained in detail with reference to the accompanying drawings.

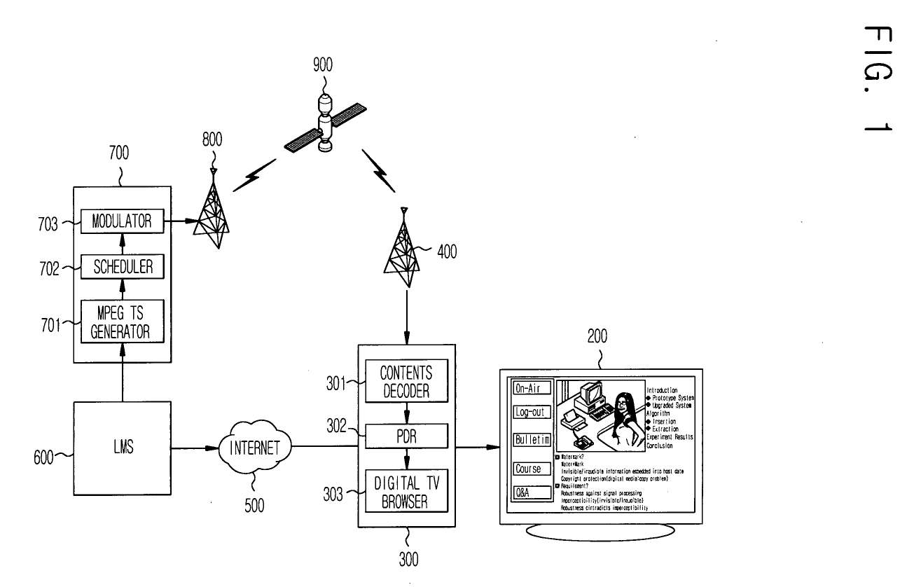

FIG. 1 is a block diagram of an apparatus for a SCORM-based e-learning contents service in a digital broadcasting system according to an embodiment of the present invention.

Referring to FIG. 1, the apparatus for a SCORM-based e-learning contents service in a digital broadcasting system according to an embodiment of the present invention includes a set top box 300 for transmitting information about a kind of terminal through a return channel and the Internet 500 and then reproducing a learning transport stream (TS) received through a broadcasting network and a receiving satellite antenna 400 on a digital television (TV) receiver 200 in accordance with received XML (Extensible Markup Language) sync information if a user is authenticated, a learning management system (LMS) 600 for transmitting an API adaptor supportable in the set top box 300 through the return channel and the Internet 500 in accordance with the terminal kind information transmitted from the set top box 300, and a digital TV transmitter 700 for generating the learning TS by packaging learning moving-picture data, learning data and sequencing information transmitted from the LMS 600, generating the XML sync information, and then transmitting the learning TS and the XML sync information through a transmitting satellite antenna 800 and the broadcasting network.

The set top box 300 includes a contents decoder 301 for decoding the learning TS and the XML sync information received through the receiving satellite antenna 400, a PDR (Personal Data Recorder) 302 for storing the learning TS and the XML sync information decoded by the contents decoder 301 in the form of a directory, and a digital TV browser 303 for reproducing the learning TS stored in the PDR 302 on the digital TV in accordance with the XML sync information.

The digital TV browser 300 extracts a sync time and an event ID by parsing the XML sync information, and controls the synchronization of the learning moving-picture data and the learning data accordingly.

The digital TV transmitter 700 includes an MPEG TS generator 701 for generating the learning TS by inserting the learning data and the sequencing information into a null packet of the learning moving-picture data transmitted from the LMS 600, and generating the XML sync information, a scheduler 702 for transmitting the learning TS and the XML sync information generated from the MPEG TS generator 701 in accordance with a preset schedule, and a modulator 703 for modulating the learning TS and the XML sync information transmitted from the scheduler 702 and transmitting the modulated learning TS and XML sync information through the broadcasting network.

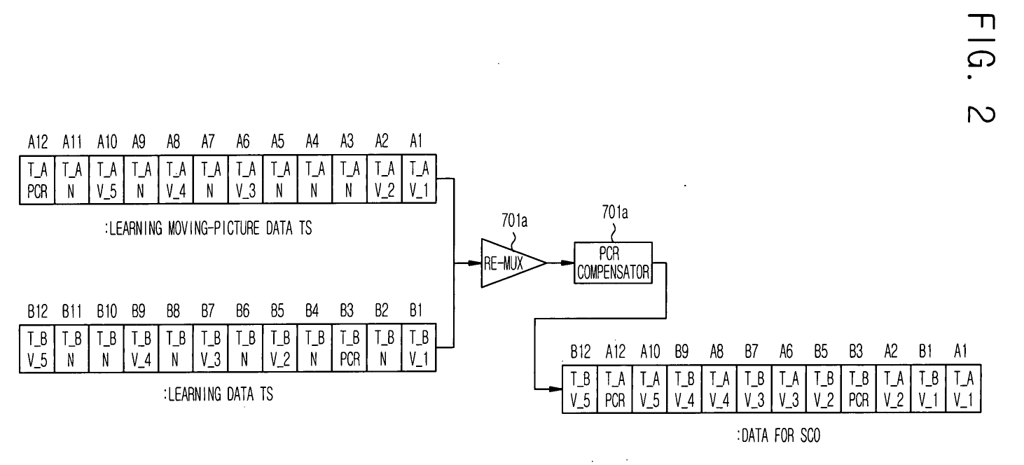

FIG. 2 is a block diagram of the MPEG TS generator illustrated in FIG. 1.

As illustrated in FIG. 2, the MPEG TS generator 701 includes a remultiplexer 701a for generating the learning TS by remultiplexing the learning moving-picture data and the learning data, and a PCR compensator 701b for compensating for a PCR of the learning TS generated from the remultiplexer 701a.

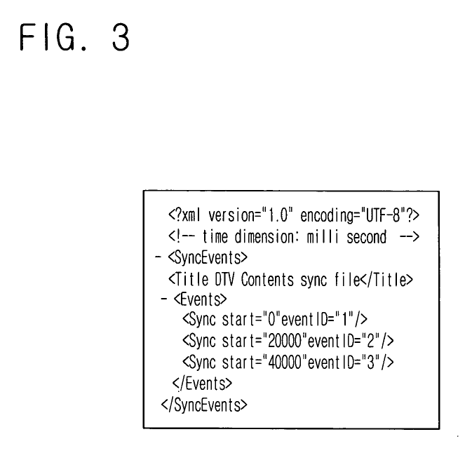

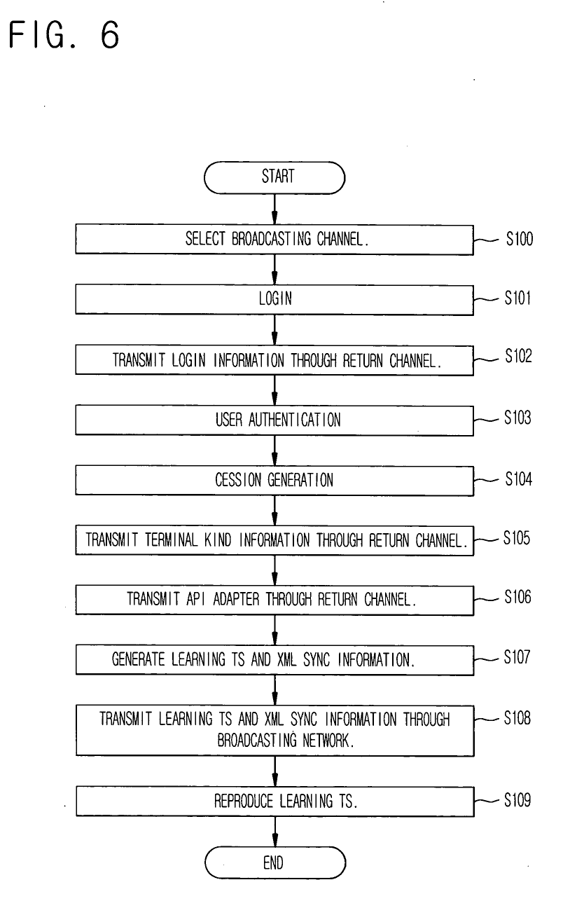

The operation of the apparatus for a SCORM-based e-learning contents server in a digital broadcasting system as constructed above according to an embodiment of the present invention will now be explained in detail with reference to FIGS. 3 to 6.

If the user selects a broadcasting channel (step S100) and then performs a login (step S101), the set top box 300 transmits login information to the LMS 600 through the return channel and the Internet 500.

The LMS 600 generates a cession (step S104) after the user is authenticated (step S103).

Through this cession, the leamer's learning procedure can be performed or traced through CMI data and a RTE (Run Time Environment) as defined in the SCORM. Although the digital broadcasting system decodes a CAS (Conditional Access System) using a smart card of an STB, the apparatus according to the present invention controls the set top box 300 through an LMS authentication because the whole procedure should be performed through the LMS 600.

The set top box 300 transmits the terminal kind information to the LMS 600 through the return channel and the Internet 500 (step S105).

The LMS 600 transmits the API adaptor supportable in the set top box 300 to the set top box 300 through the return channel and the Internet 500 in accordance with the terminal kind information.

Currently, the PC-based API adaptor supports a version of more than Java 1.2, but cannot support a java 1.2 version. Accordingly, the API adaptor is transmitted in the forms of a child frame of an LMS main frame characterized to match the digital TV receiver 200 in character size and so on.

The PC-based learning contents are basically composed of HTML, and the API defined in the SCORM is hard-coded in an HTML code. If the SCORM API is encountered during the execution of the transmitted e-learning contents, the e-learning is expedited by sending and receiving the LMS and CMI data according to the defined in the API adaptor transmitted from the LMS.

In the case of the e-learning through a real-time broadcasting, only a flow system is supported in accordance with the characteristic of the digital broadcasting system. However, in the case of an e-learning scenario through the PDR 302, a choice system is supported because all the SCOs (Sharable Content Objects) are stored in the PDR 302.

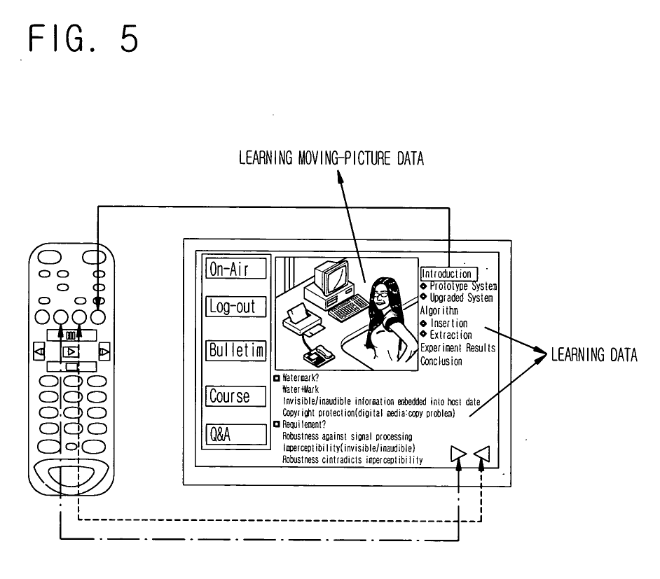

Referring to FIG. 5, if a color button of a remote controller 100 is pressed, the sequencing information is reproduced on the digital TV receiver. That is, since a function that is called when a certain color button is pressed has already been determined in the data broadcasting standard such as ACAP, DVB-MHP, etc., the sequencing information can be shown by connecting the called function to a function showSequencing showing the sequencing if the button is pressed.

Additionally, the following APIs are newly defined:

showSequencing: for indicating sequencing information

getNextSCO: for obtaining information of the next SCO

getPreviousSCO: for obtaining information of the previous SCO

showCurrent SCO: for executing the presently selected SCO

showNextSCO: for selecting and executing the next SCO

showPreviousSCO: for selecting and executing the previous SCO

Meanwhile, the remultiplexer 701a of the MPEG TS generator 701 in the digital TV transmitter 700 generates the learning TS by remultiplexing the learning moving-picture data and the learning data, and then generates the XML sync information (step S107). The PCR compensator 701b of the MPEG TS generator 701 compensates for the PCR of the generated learning TS, and outputs the compensated learning TS to the scheduler 702.

The matters that demand special attention when the learning TS is generated are as follows:

First is to synchronize the learning moving-picture data with the learning data. This synchronization can be implemented using a “stream event” technology, but this technology has several drawbacks. That is, it takes a lot of time in implementing the synchronization, and a dedicated server is required. Accordingly, in the present invention, the terminal receives and analyzes the sync information in the form of an XML, and reproduces the learning data in accordance with the XML sync information.

The form of the sync information used in the present invention is as illustrated in FIG. 3.

The digital TV browser 300 installed in the set top box 300 parses the XML sync information and transmits the sync time and event ID to the corresponding program to control the synchronization of the moving picture with the learning data.

Second is to package the learning moving-picture data and the learning data together. In the present invention, as illustrated in FIG. 2, a TS remultiplexing (re-muxing) technology is used to insert the learning data into the null packet of the learning moving-picture data (i.e., A/V data).

Generally, the time when the user starts the learning may be different from the time when the learning is transmitted according to the schedule of the corresponding broadcasting station. Accordingly, a user who accesses the broadcasting channel in the middle of the broadcasting may not receive the learning data previously broadcast. In order to solve this problem, the learning data is repeatedly inserted into the null packets so far as the null packets exist.

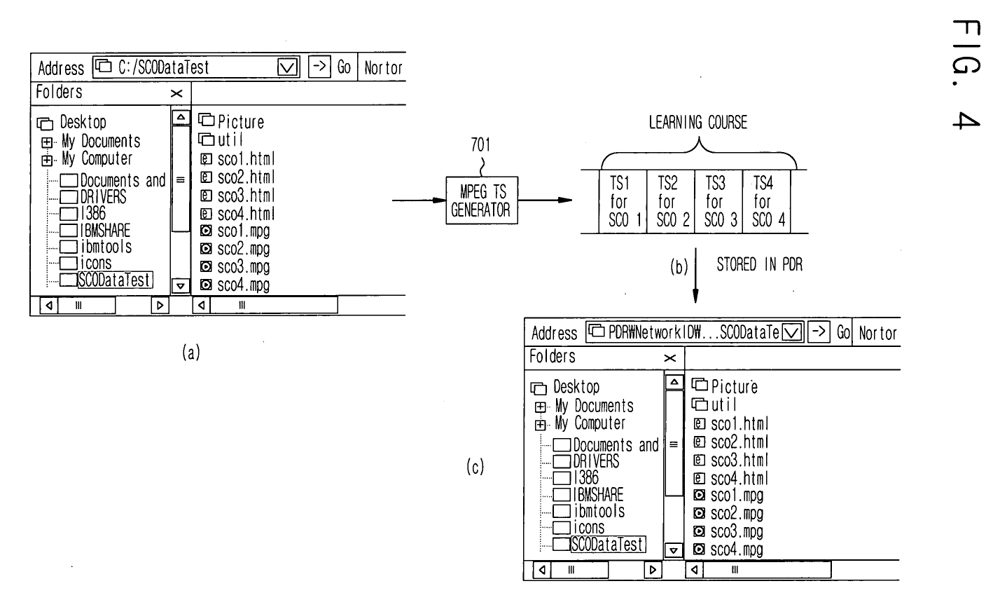

The SCO (Sharable Content Object) made on the basis of a PC generally has a directory structure as illustrated in FIG. 4.

For one SCO, there are moving-picture files SCO.mpg, learning data files SCO.html, gathered scripts and other gathered images used in HTML. In the present invention, since the stream event is not used, the TS is prepared for each SCO. According to this method, it is easy to manage the SCO when it is stored in the PDR 302, and it is easy to perform an access in the unit of a SCO such as getNextSCO and so on since the individual SCO can directly be accessed through the sequencing information.

Third is the sequencing information. The PC-based system generates and stores the sequencing information in the LMS by analyzing a manifest file when the learning contents are imported into the LMS. The PC-based system receives the sequencing information from the LMS and executes the next SCO. However, this cannot be used in the broadcasting system environment. The reason is as follows. The sequencing information should exist in a broadcasting server since the sequencing information is a kind of broadcasting schedule. Additionally, the sequencing information stored in the LMS has URL information as information about the contents for a PC. If the set top box accesses the sequencing information, the set top box would receive the next SCO downloaded from the web server designated in the URL through the return channel. This conflicts with the scenario intended in the present invention. Accordingly, in the present invention, the sequencing information is inserted into the learning TS together with the learning data.

Then, the scheduler 702 outputs the learning TS in accordance with the preset schedule, and the modulator 703 modulates the learning TS output from the scheduler 702 and transmits the modulated learning TS through the transmitting satellite antenna 800 and the broadcasting network (step S108).

Then, the contents decoder 301 of the set top box 300 receives and decodes the learning TS and the XML sync information transmitted through the broadcasting network. The PDR 302 of the set top box 300 stores the learning TS and the XML sync information decoded by the contents decoder 301 in the form of a directory. The digital TV browser 303 directly reproduces the learning moving-picture data through the digital TV receiver 200 and reproduces the learning data according to the XML sync information (step S109).

As described above, according to the apparatus and method for a SCORM-based e-learning contents server in a digital broadcasting system according to the present invention, the standard e-learning system (i.e., SCORM) in which the reuse of the e-learning contents and the trace of the e-learning procedure are possible can be used in the digital broadcasting system.

Additionally, although the digital broadcasting system has the disadvantage that it has poor user-interaction and bidirectionality in comparison to the PC, it has the advantage that several billions of people can simultaneously learn through it. If several billions of people intend to simultaneously learn with a high picture quality in the PC-based system, the system would shortly shut down. Meanwhile, the learning through TV is very interesting. Since the TV is a medium greatly familiar with a human, the learning through the TV is greatly effective. According to materials for research work, children and old people are well acquainted with TV rather than PC. Accordingly, the present invention can activate the T-learning industries by proposing first in the world the method for supporting the SCORM that is the standard greatly used for the reuse of T-learning contents which are given quite important weight in learning.

While the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. An apparatus for a SCORM (Sharable Content Object Reference Model)-based e-learning contents service in a digital broadcasting system, the apparatus comprising:
a set top box for transmitting information about a kind of terminal through a return channel and then reproducing a learning transport stream (TS) received through a broadcasting network on a digital television (TV) receiver in accordance with received XML (Extensible Markup Language) sync information if a user is authenticated;
a learning management system for transmitting an API adaptor supportable in the set top box through the return channel in accordance with the terminal kind information transmitted from the set top box; and
a digital TV transmitter for generating the learning TS by packaging learning moving-picture data, learning data and sequencing information transmitted from the learning management system, generating the XML sync information, and transmitting the learning TS and the XML sync information through the broadcasting network.

2. The apparatus as claimed in claim 1, wherein the set top box comprises:
a contents decoder for decoding the learning TS and the XML sync information received through the broadcasting network;
a PDR (Personal Data Recorder) for storing the learning TS and the XML sync information decoded by the contents decoder in the form of a directory; and
a digital TV browser for reproducing the learning TS stored in the PDR on the digital TV in accordance with the XML sync information.

3. The apparatus as claimed in claim 2, wherein the digital TV browser extracts a sync time and an event ID by parsing the XML sync information, and controls the synchronization of the learning moving-picture data and the learning data accordingly.

4. The apparatus as claimed in claim 1, wherein the digital TV transmitter comprises:
an MPEG TS generator for generating the learning TS by inserting the learning data and the sequencing information into a null packet of the learning moving-picture data transmitted from the learning management system, and generating the XML sync information;
a scheduler for transmitting the learning TS and the XML sync information generated from the MPEG TS generator in accordance with a preset schedule; and
a modulator for modulating the learning TS and the XML sync information transmitted from the scheduler, and transmitting the modulated learning TS and XML sync information through the broadcasting network.

5. The apparatus as claimed in claim 4, wherein the MPEG TS generator comprises:
a remultiplexer for generating the learning TS by remultiplexing the learning moving-picture data and the learning data; and
a PCR compensator for compensating for a PCR of the learning TS generated from the remultiplexer.

6. A method for a SCORM (Sharable Content Object Reference Model)-based e-learning contents service in a digital broadcasting system, the method comprising:
a first step of transmitting login information through a return channel if a login is performed after a user selects a broadcasting channel;
a second step of transmitting information about a kind of terminal through the return channel if a cession is generated after the user is authenticated;
a third step of transmitting an API adaptor supportable in a set top box through the return channel in accordance with the terminal kind information;
a fourth step of generating a learning transport stream (TS) and XML (Extensible Markup Language) sync information;
a fifth step of transmitting the learning TS and the XML sync information through a broadcasting network; and
a sixth step of reproducing the learning TS in accordance with the XML sync information received through the broadcasting network.

7. The method as claimed in claim 6, wherein the learning TS at the fourth step includes learning moving-picture data, learning data and sequencing information.

8. The method as claimed in claim 6, wherein the sixth step comprises:
a first substep of decoding the learning TS and the XML sync information;
a second substep of storing the learning TS and the XML sync information decoded at the first substep in a PDR (Personal Data Recorder) in the form of a directory; and
a third substep of reproducing the learning moving-picture data among the learning TS stored at the second substep directly through a digital television receiver, and reproducing the learning data in accordance with the XML sync information.
